(19) United States
(12) Patent Application Publication
(10) Pub. No.: US 2012/0072759 A1
(43) Pub. Date: Mar. 22, 2012

(54) Timing Error Correction System and Method

(75) Inventors: Zhaolei Wu, Chengdu (CN); Guosheng Wu, Chengdu (CN)

(73) Assignee: IPGoal Microelectronics (SiChuan) Co., Ltd.

(21) Appl. No.: 12/939,116

(22) Filed: Nov. 3, 2010

(30) Foreign Application Priority Data
Sep. 21, 2010 (CN) 201010288369.9

(51) Int. Cl. G06F 1/12

(52) U.S. Cl. 713/401

(57) ABSTRACT

A timing error correction method used at the transmitting end in high-speed serial data transmission system comprises inputting a predefined parallel data training sequence and a clock signal, converting the training sequence into serial data, counting the number of the rising or falling edges of the serial data within a certain period, sending an adjustment signal for adjusting the time delay of the clock signal, obtaining a reasonable serialization timing, so that the number of the rising edges or falling edges of the serial data being equal to a predefined correct number. The corresponding timing error correction system comprises a data path, an adjustable delay clock path, a serialization unit for converting the parallel data into serial data, a driver unit, and a counting judging unit for counting the number of the rising or falling edges of the serial data and sending an adjustment signal to the adjustable delay clock path so as to control the timing of the serialization unit.

### BACKGROUND

1. Field of the Invention

The present invention relates to a timing error correction system and corresponding method, more particularly, to an error correction system and method for the timing of the transmitter in the high-speed serial data transmission system.

2. Description of Related Arts

In the high-speed serial data transmission system, very often, the transmitting end serializes parallel data at half a clock speed; namely, the clock cycle is half a data bit width. During serializing parallel data, due to the increasing data rate, the timing is very likely to get wrong; especially, when the technique, power supply, temperature or other factors changes, the timing issue becomes more troublesome.

During the serialization process, the delay skew of a synchronous clock and data in their respective path will not make the timing of the clock and the data meet the requirements of data serialization, and eventually cause the serialized data to jitter greatly, and even lead to erroneous data bit.

### SUMMARY OF THE PRESENT INVENTION

It is an objective of the present invention to provide a timing error correction system of the transmitting end of a high-speed serial data transmission system, which can automatically detect the timing of data serialization and correct timing skew.

According to the present invention, the correction system for timing error comprises a data path for receiving parallel data, an adjustable delay clock path for receiving a clock signal, a serialization unit connected with the data path and the adjustable delay clock path for converting the parallel data into serial data, a driver unit for converting the serial data into a current or voltage signal and outputting the current or voltage, and a counting judging unit for counting the number of the rising edges or falling edges of the serial data, and sending an adjustment signal for adjusting the time delay of the clock signal to the adjustable delay clock path, so as to control the timing of the serialization unit and accordingly to make the number of the rising edges or falling edges of the serial data be equal to a predefined desired number.

By making the number of the rising edges or falling edges of the serial data be equal to the desire number, the timing of the serialization unit can come to the optimum value.

It is the other objective of the present invention to provide a timing error correction method of the transmitter in a high-speed serial data transmission system.

The method comprises:

Inputting a predefined parallel data training sequence and a clock signal;

Converting the parallel data training sequence into serial data;

Counting the number of the rising edges or falling edges of the serial data within a certain period;

Sending an adjustment signal for adjusting the time delay of the clock signal;

Making the number of the rising edges or falling edges of the serial data be equal to a predefined correct number to obtain desired serialization timing;

The transmitting end of the serial data transmission system starts to transmit subsequent normal data.

Various implementations may include one or more of the following advantages. Compared to the existing technologies, by using the training sequence in the serialization process, the present invention can detect the serialization timing, adjust the timing to get optimum timing, and only after having adjusted the timing start the serialization and sending of normal data; therefore, it effectively solves the timing issue in the serialization.

These and other objectives, features and advantages of the present invention, will become apparent from the following detailed description, the accompanying drawings, and the appended claims.

### BRIEF DESCRIPTION OF DRAWINGS

FIG. 1 is a systematic block diagram of a preferred embodiment of the error correction system of the present invention;

FIG. 2 is a flow chart of the preferred embodiment of the error correction method of the present invention works;

FIG. 3 is a schematic diagram of the working principle of the preferred embodiment of the error correction system and method of the present invention;

FIG. 4 is the schematic waveform of the desired serialization timing of the preferred embodiment of the present invention;

FIG. 5 is the schematic waveform of the timing sequence when the clock is advanced;

FIG. 6 is the schematic waveform of the timing sequence when the clock lags.

### DETAILED DESCRIPTION OF PREFERRED EMBODIMENTS

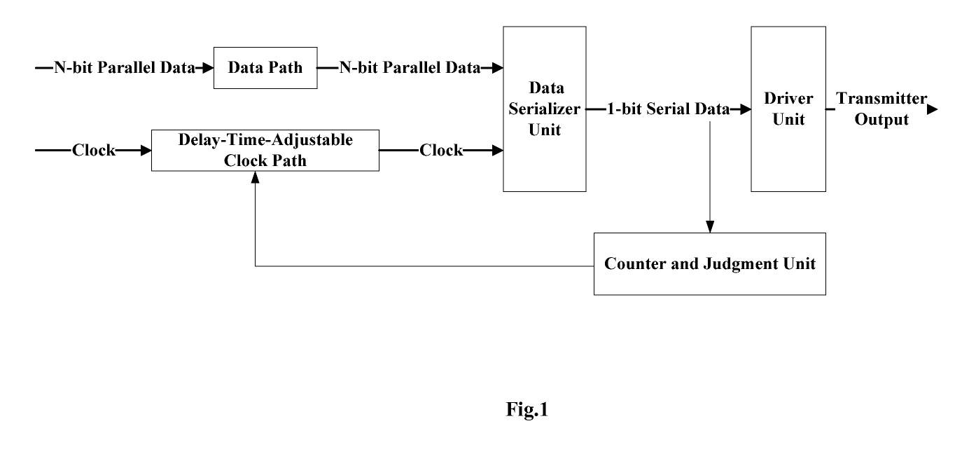

Referring to FIG. 1, a timing error correction system is used at the transmitting end of a high-speed serial data transmission system. It comprises a data path, an adjustable delay clock path, a serialization unit connected with the data path and the adjustable delay clock path for converting parallel data into serial data, a driver unit for converting the serial data into a current or voltage signal, and a counting judging unit. An N-bit parallel data is inputted through the data path to the serialization unit. A clock signal is inputted through the adjustable delay clock path to the serialization unit. After serializing the N-bit parallel data, the serialization unit outputs a 1-bit serial data to the driver unit and the counting judging unit. The counting judging unit counts the number of the rising edges or falling edges of the serial data, judges whether the number is the same as a predefined correct number, and then sends an adjustment signal for controlling the time delay of the clock signal to the adjustable delay clock path, so as to control the serialization timing of the serialization unit. Then, the driver unit outputs the serialized data through the transmitting end.

Before sending a desired data, a predefined parallel data training sequence is sent first to the data path in order to test and adjust the timing of the serialization unit. The serialization unit will convert the training sequence into a serial data and outputs it to the driver unit and counting judging unit.

Since the training sequence and the transmission time are defined by users in advance, the number of the rising or falling edge of such training sequence within a certain period is a fixed value. The counting judging unit can figure out the number of the rising edges or falling edges in the serial data within a certain time and do a delayed scan to the adjustable delay clock path by sending an adjustment signal; namely, control the amount of the time delay with the order from big to small, or from small to big. When the time delay of the clock signal, relative to the data, gets less, it shows that the sampling time of the clock signal is advanced; as a result, the timing goes wrong, specifically, the number of the rising edges or falling edges of the serial data outputted from the serialization unit gets more. When the time delay of the clock signal, relative to the data, gets bigger, it shows that the sampling time of the clock signal lags; as a result, the timing goes wrong, and the number of the rising edges or falling edges of the serial data outputted from the serialization unit gets more. Because the probability of the advance and lag of the sampling time of the clock signal is the same, after finding the time when the two statuses mentioned above both occur as doing delayed scan, an optimum timing can be obtained through making the adjustment signal be in the middle status of the two statuses by the counting judging unit. The timing at this moment is the optimum sampling timing; the number of the rising edges or falling edges of the serial data is the same as the predefined correct number.

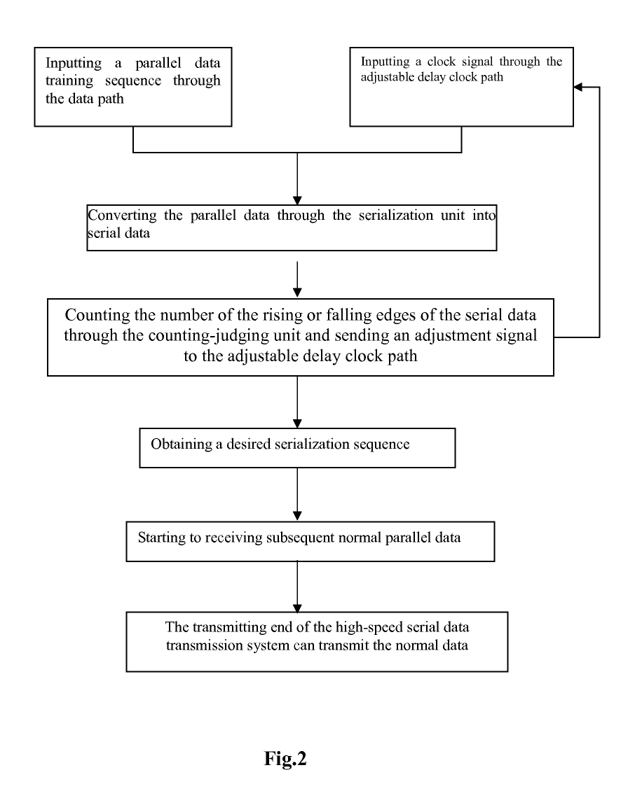

Referring to FIG. 2, the steps of the preferred embodiment of the method of the present invention is as follows:

1. Input a parallel data training sequence set in advance through the data path and input a clock signal through the adjustable delay clock path.

2. Convert the parallel data training sequence into serial data through the serialization unit.

3. The counting judging unit figures out the number of the rising edges or falling edges of the serial data within a set time and sends an adjustment signal to the adjustable delay clock path to control the time delay of the clock signal.

4. The counting judging unit controls the time delay of the clock signal by the rule of from big to small or from small to big through the adjustment signal. When the time delay of the clock signal, relative to the data, gets less, it shows that the sampling time of the clock signal is advanced; as a result, the timing goes wrong, specifically, the number of the rising edges or falling edges of the serial data outputted from the serialization unit gets more. When the time delay of the clock signal, relative to the data, gets bigger, it shows that the sampling time of the clock signal lags; as a result, the timing goes wrong, and the number of the rising edges or falling edges of the serial data outputted from the serialization unit gets more. Because the probability of advance and lag of the sampling time of the clock signal is the same, after finding the time when the two statuses mentioned above both occur when doing delayed scan, an optimum timing can be obtained through making the adjustment signal be in the middle status of the two statuses by the counting judging unit. The timing at this moment is the optimum sampling timing; the number of the rising edges or falling edges of the serial data is the same as the predefined correct number.

5. A normal parallel data is inputted to the data path, is converted through the serialization unit into serial data, and is converted through the driver unit into a current or voltage signal.

6. The transmitting end of the transmission system continues the transmission of normal data.

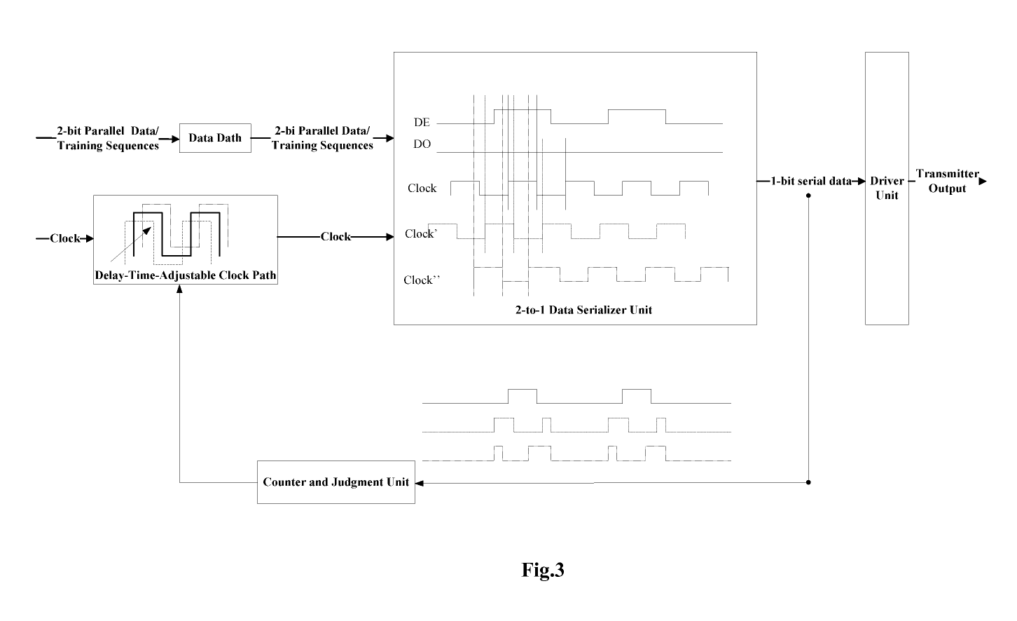

Referring to FIG. 3, a 2-bit parallel data is taken as an example to illustrate how the error correction system and method work.

First, send a 2-bit parallel data training sequence; one is the first parallel data “***01010101***” and the other is the second parallel data “***00000000***”. When the clock signal is a high level, the first parallel data is chose, while the clock signal is a low level, the second parallel data is chose.

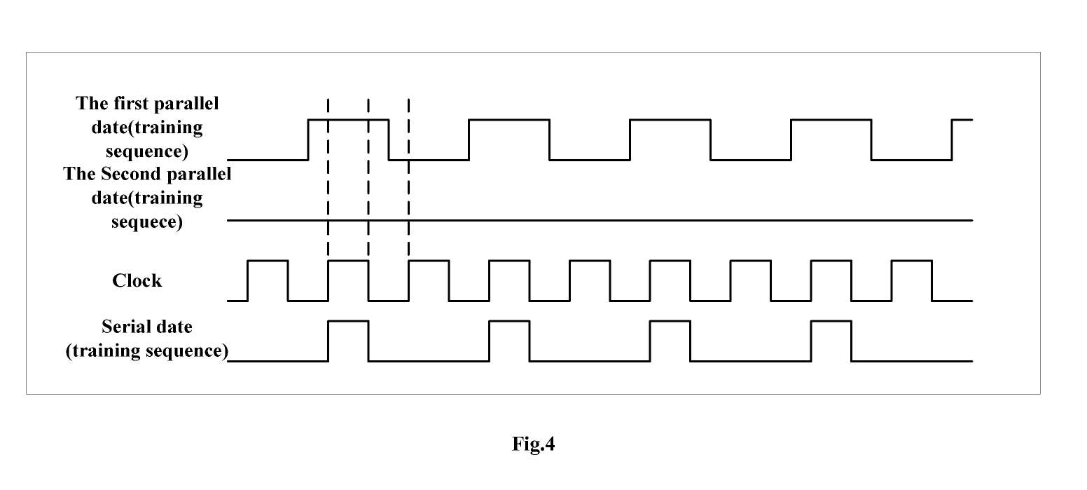

Referring to FIG. 3 and FIG. 4, when the timing of the serialization unit is correct, the parallel data will be converted into a serial data by the serialization unit, which is “******0010001000100010*******”, with a fixed number of rising edges or falling edges, i.e., 25 rising edges or 25 falling edges will appear in every 100 data bits.

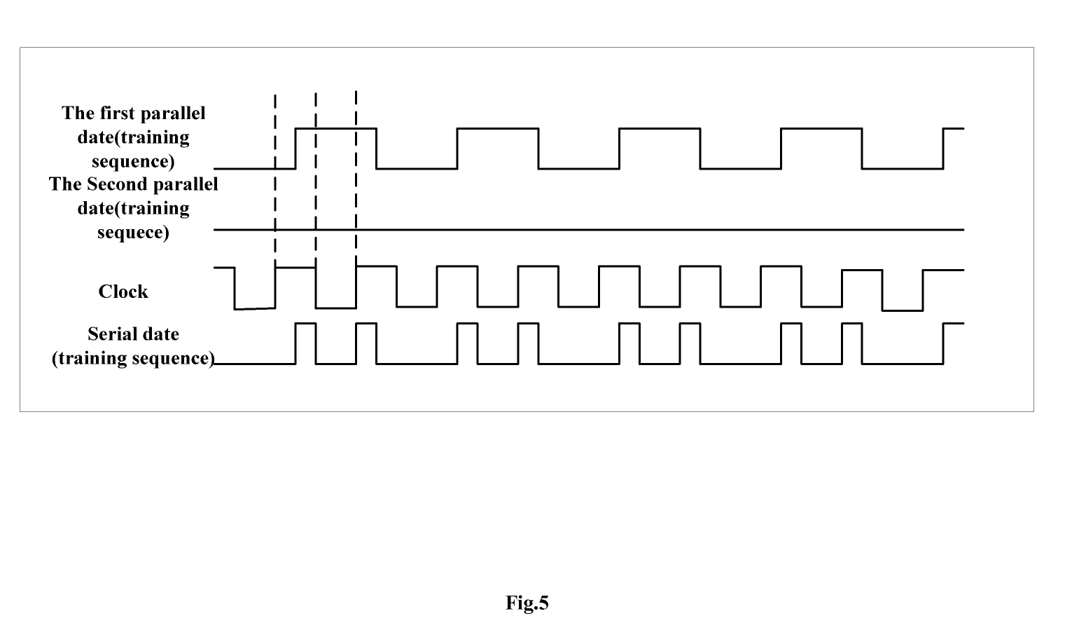

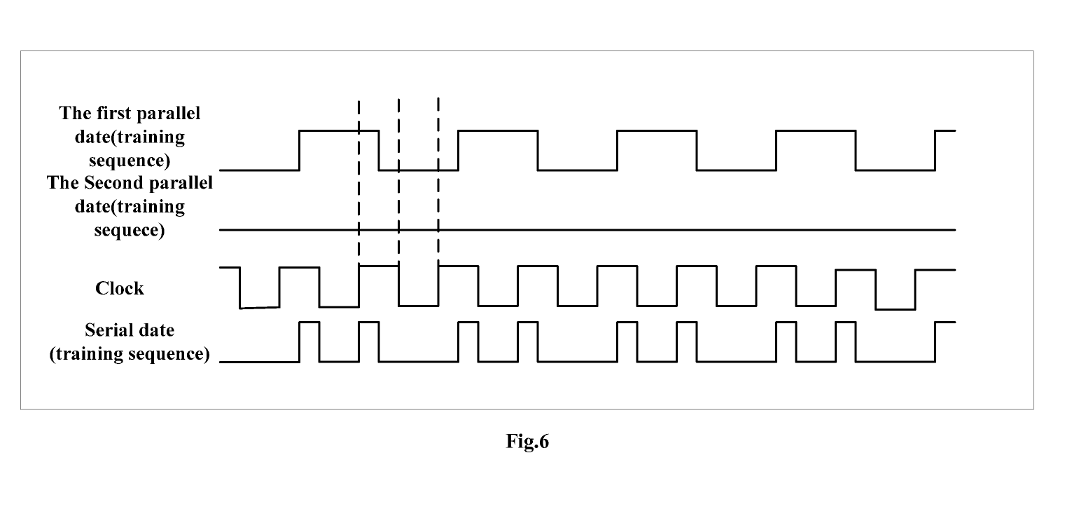

However, due to the variation of the process, power supply, temperature and other factors, the timing of an actual circuit might not be the same as it was expected. The time delay on the clock path might be longer or shorter, and eventually causes a timing error. In this embodiment, when the time delay gets longer, which means the clock lags, as shown in FIG. 3 and FIG. 6, the resulting erroneous serial data is “******1010010100******”, wherein 50 rising edges or falling edges appear. If the time delay gets shorter, which means the clock gets advanced, as shown in FIG. 3 and FIG. 5, the erroneous output is “******1010010100******” and also with 50 rising or falling edges, which is the double of the correct number.

To fix the problem, the counting judging unit will send an adjustment signal to control the time delay of the adjustable delay clock path; namely, to control the time delay by the rule of from big to small or oppositely. When the time delay of the clock signal, relative to the data, becomes less, it shows that the sampling time of the clock signal is advanced; as a result, the timing goes wrong, specifically, the number of the rising edges or falling edges of the serial data outputted from the serialization unit gets more. When the time delay of the clock signal, relative to the data, becomes more, it shows that the sampling time of the clock signal lags; as a result, the timing goes wrong, and the number of the rising edges or falling edges of the serial data outputted from the serialization unit gets more. Because the probability of advance and lag of the sampling time of the clock signal is the same, after finding the time when the two statuses mentioned above both occur when doing delayed scan, an optimum timing can be obtained through making the adjustment signal be in the middle status of the two statuses by the counting judging unit. The timing at this moment is the optimum sampling timing; the number of the rising edges or falling edges of the serial data is the same as the predefined correct number.

Once the timing of the serialization unit has been successfully adjusted to a correct status through the 2-bit parallel data training sequence, the subsequent normal parallel data can be inputted to be serialized and transmitted.

The present invention utilizes a training sequence to detect and adjust the serialization timing, thereby obtaining desired serialization timing. The normal data will not be serialized and transmitted, until the adjustment of the timing in virtue of the training sequence has been finished.

One skilled in the art will understand that the embodiments of the present invention as shown in the drawings and described above are exemplary only and not intended to be limiting.

It will thus be seen that the objects of the present invention have been fully and effectively accomplished. Its embodiments have been shown and described for the purpose of illustrating the functional and structural principles of the present invention and is subject to change without departure from such principles. Therefore, this invention includes all modifications encompassed within the spirit and scope of the following claims.

What is claimed is:

1. A timing error correction system, used at the transmitting end in a high-speed serial transmission system, comprising:
a data path for receiving parallel data;
an adjustable delay clock path for receiving a clock signal;
a serialization unit connected with the data path and the adjustable delay clock path for converting the parallel data into serial data;
a driver unit for converting the serial data into a current or voltage signal and outputting the current or voltage; and
a counting judging unit for counting the number of the rising edges or falling edges of the serial data and sending an adjustment signal for adjusting the time delay of the clock signal to the adjustable delay clock path so as to control the timing of the serialization unit and accordingly to make the number of the rising edges or falling edges of the serial data be equal to a predefined desired number.

2. The timing error correction system, used at the transmitting end in a high-speed serial transmission system, recited as claim 1, wherein the serialization unit converts the parallel data into the serial data at half a clock speed; namely, a clock cycle is half a data bit width.

3. The timing error correction system, used at the transmitting end in a high-speed serial transmission system, recited as claim 1, wherein the parallel data is sent through the data path to the serialization unit; the clock signal is sent through the adjustable delay clock path to the serialization unit.

4. The timing error correction system, used at the transmitting end in a high-speed serial transmission system, recited as claim 3, wherein after converting the parallel data into the serial data, the serialization unit sends the serial data to the driver unit and the counting judging unit.

5. A timing error correction method, used at the transmitting end in a high-speed serial data transmission system, comprising:
inputting a predefined parallel data training sequence and a clock signal;
converting the parallel data training sequence into serial data;
counting the number of the rising edges or falling edges of the serial data within a certain period;
sending an adjustment signal for adjusting the time delay of the clock signal;
obtaining a reasonable serialization timing, so that the number of the rising edges or falling edges of the serial data being equal to a predefined correct number;
the transmitting end starting to transmit subsequent normal data.

6. The timing error correction method, used at the transmitting end in a high-speed serial data transmission system, recited as claim 5, wherein the parallel data training sequence is sent through a data path to a serialization unit; the clock signal is sent through an adjustable delay clock path to the serialization unit; the serialization unit converts the parallel data training sequence into serial data.

7. The timing error correction method, used at the transmitting end in a high-speed serial data transmission system, recited as claim 6, wherein the number of the rising or falling edges of the serial data with a certain period is figured out by a counting judging unit; the adjustment signal for controlling the time delay of the clock signal is also sent by the counting judging unit.

8. The timing error correction method, used at the transmitting end in a high-speed serial data transmission system, recited as claim 7, wherein obtaining the reasonable serialization timing further comprises the following steps:
The counting judging unit does a delayed scan to the adjustable delay clock path through sending the adjustment signal;
After finding the time when an advance status and a lag status of the sampling time of the clock signal occur, the counting judging unit makes the adjustment signal be in the intermediate status of the advance status and the lag status.

9. The timing error correction method, used at the transmitting end in a high-speed serial data transmission system, recited as claim 8, wherein when the time delay of the clock signal, relative to the data, gets less, it shows that the sampling time of the clock signal is advanced; as a result, the timing goes wrong, specifically, the number of the rising edges or falling edges of the serial data outputted from the serialization unit gets more; when the time delay of the clock signal, relative to the data, gets bigger, it shows that the sampling time of the clock signal lags; as a result, the timing goes wrong, and the number of the rising edges or falling edges of the serial data outputted from the serialization unit gets more.
